(19) United States
(12) Patent Application Publication
(10) Pub. No.: US 2018/0158092 A1
(43) Pub. Date: Jun. 7, 2018

(54) PROVIDING USER INCENTIVES

(71) Applicant: Bank of America Corporation, Charlotte, NC (US)

(72) Inventors: Joseph B. Castinado, Northglenn, CO (US); Sean Michael Gutman, Waxhaw, CO (US)

(21) Appl. No.: 15/370,573

(22) Filed: Dec. 6, 2016

(51) Int. Cl. G06Q 30/02; G06Q 40/02

(52) U.S. Cl. CPC G06Q 30/0226; G06Q 40/02

(57) ABSTRACT

A system for providing user incentives includes a memory that includes a database of user information, user transaction information, and user incentive information, an interface operable to receive user information, user transaction information, and user incentive information, and one or more processors operable to determine that a user has conducted a transaction using an account, determine, based on the received transaction information, that the user has satisfied the conditions to qualify for a user incentive, determine a user action for the user to complete in order to receive the incentive, generate a communication to a communication device associated with the user notifying the user of the incentive and the user action required for the user to receive the incentive, determine that the user has completed the user action, and communicate the user incentive to the user.

### TECHNICAL FIELD

This disclosure relates generally to providing user incentives, and more particularly to incentivizing user interaction by providing user incentives customized to users and to vendors sponsoring the incentive.

### BACKGROUND

Enterprises often try to incentivize user (e.g., customer) interactions by providing incentives. For example, airlines have frequent flier reward programs to incentivize customers to fly on their airline.

### SUMMARY OF EXAMPLE EMBODIMENTS

According to embodiments of the present disclosure, disadvantages and problems associated with providing internal services to external enterprises may be reduced or eliminated.

In certain embodiments, a system for providing user incentives includes a memory that includes a database of user information, user transaction information, and user incentive information, an interface operable to receive user information, user transaction information, and user incentive information, and one or more processors operable to determine that a user has conducted a transaction using an account, determine, based on the received transaction information, that the user has satisfied the conditions to qualify for a user incentive, determine a user action for the user to complete in order to receive the incentive, generate a communication to a communication device associated with the user notifying the user of the incentive and the user action required for the user to receive the incentive, determine that the user has completed the user action, and communicate the user incentive to the user.

Certain embodiments of the present disclosure may provide one or more technical advantages having specific technical effects.

In certain embodiments, system 100 is operable to facilitate vendors targeting specific groups of customers according to sensitive user information and user transaction information without revealing that information to the vendors, thereby maintaining the security of sensitive user information.

In particular embodiments, system 100 is operable to communicate vendor incentives to targeted customers at times the targeted customers are likely to be most receptive to the vendor incentive, thereby conserving computing resources and bandwidth consumed by communicating untargeted vendor incentives (e.g., needing more communications for the same outcome).

In another embodiment, system 100 is operable to communicate vendor incentives to targeted customers when the targeted customers are located near the sponsoring vendor and likely to be most receptive to the vendor incentive, thereby conserving computing resources and bandwidth consumed by communicating untargeted vendor incentives (e.g., needing more communications for the same outcome).

In yet another embodiment, system 100 is operable to communicate vendor incentives to targeted customers based on the customers' account transaction history, thereby conserving computing resources and bandwidth consumed by communicating untargeted vendor incentives (e.g., needing more communications for the same outcome).

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an example system for providing user incentives, according to certain embodiments of the present disclosure;

FIG. 2 illustrates a table of user information in an example system for providing user incentives, according to certain embodiments of the present disclosure;

FIG. 3 illustrates a table of vendor incentive information in an example system for providing user incentives, according to certain embodiments of the present disclosure;

FIG. 4 illustrates a flow diagram of an example method for providing user incentives, according to certain embodiments of the present disclosure.

### DETAILED DESCRIPTION

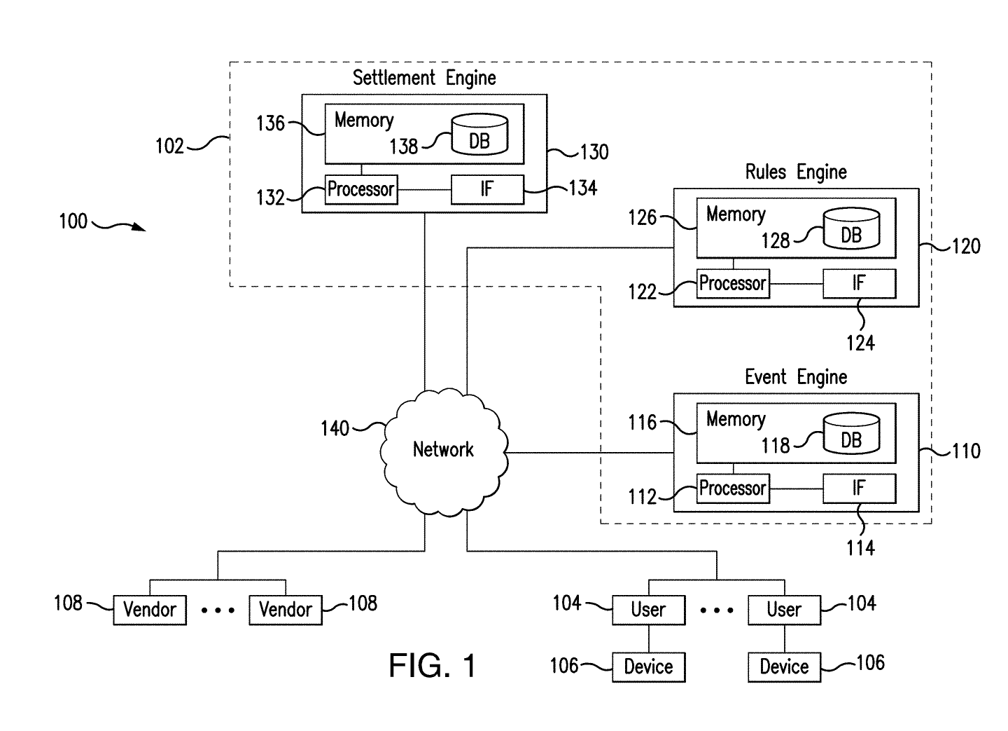

Embodiments of the present disclosure and its advantages are best understood by referring to FIGS. 1 through 4 of the drawings, like numerals being used for like and corresponding parts of the various drawings.

The present system allows for an enterprise to provide high value incentives to users to interact with the enterprise by maximizing the value of the incentives to both users and to vendors sponsoring the incentives. In an example, the enterprise has access to transaction information associated with a user account and/or user information associated with users, and is be able to detect events (such as transactions) in near real-time. Based on the transaction and user information, the enterprise can identify incentives that would have the highest value to particular users and to present those incentives at times when users are most interested in receiving the incentive. Additionally, the system can provide highly targeted users for vendors sponsoring incentives, thereby increasing the value of incentives that vendors are willing to offer. Further, the enterprise benefits from high value incentives because those high value incentives are more likely to motivate a customer to perform required interactions with the enterprise in order to receive the high value incentive.

FIG. 1 illustrates an example system 100 for providing user incentives. According to an embodiment, system 100 includes enterprise 102, users 104, user communication devices 106, and vendors 108. Enterprise 102 may include event engine 110, rules engine 120, and settlement engine 130.

Enterprise 102 represents an entity that maintains and/or operates one or more of event engine 110, rules engine 120, and settlement engine 130. Enterprise 102 may be any suitable type of business entity. In certain embodiments, enterprise 102 has different business units or subdivisions that handle different business activities. Different subdivisions of enterprise 102 may maintain and/or operate one or more of event engine 110, rules engine 120, and settlement engine 130. In particular embodiments, enterprise 102 may include organizations such as commercial banks, savings and loan associations, credit unions, Internet banks, mutual fund companies, brokerage firms, credit card companies, or other provider of electronic transaction services. Enterprise 102 may further provide one or more applications operable to run on communication devices 104. For example, an enterprise application may provide enterprise services to users 104 (e.g., customers) through user 104 communication devices 106 (e.g., smart phones, tablets, etc.).

Users 104 represent customers and potential customers of enterprise 102. In certain embodiments, users 104 use an application running on communication devices 106 to interact with enterprise 102. Users 104 may have one or more accounts with enterprise 102 and may conduct transactions with the one or more accounts. Enterprise 102 may store information related to user 104 account transactions. For example, enterprise 102 may store the date, time, and amount of the transaction and may further store information regarding other parties to the transaction, for example, the vendor. In certain embodiments, enterprise 102 may also store information about users 104, for example, age, gender, location, interests, or other user 104 demographic information.

Communication devices 106 represent components of system 100 that provide a communication platform for users 104 to, for example, interact with enterprise 102. Communication devices 106 include smart phones, tablets, laptop computers, desktop computers, or any other suitable communication device operable to access an electronic communication network (e.g., the internet). Communication devices 106 may be operable to access standard web pages, mobile web pages, and/or execute applications (e.g., mobile applications). In certain embodiments, communication devices 106 are operable to execute an application provided by enterprise 102 that allows users 104 to interact with enterprise 102 through communication devices 106.

Vendors 108 represent businesses that provide goods and services to users 104. In certain embodiments, some vendors 108 may provide incentives (e.g., a reward, discount, offer, sale, giveaway, contests, or any other incentive) for users 104 to patronize vendors 108. Vendors 108 may be willing to provide different incentives to different users 104. For example, a coffee shop may want to provide large discounts on coffee to users 104 who regular purchase coffee but do not regularly purchase coffee from the coffee shop. In another example, the coffee shop may not see a benefit in providing large discounts on coffee to users 104 who already regularly purchase coffee from the coffee shop, but may want to provide incentives for users 104 who are existing customers to try new products offered by the coffee shop, such as food items. Vendors 108 may also be willing to provide larger discounts to users 104 the vendor 108 most wants to target. In certain embodiments, enterprise 102 can be one of vendors 108.

Event engine 110 represents a component of system 100 communicatively coupled to rules engine 120 and operable to detect events related to users 104 and vendor 108 incentives. For example, event engine 110 may detect user 104 transactions, changes in user 104 interests, changes in user 104 age, and new incentives provided by vendors 108. In certain embodiments, event engine 110 is operable to monitor transactions occurring with enterprise 102 accounts associated with users 104. Event engine 110 may further be operable to monitor information relating to users 104 from an application associated with enterprise 102 operating on communication devices 106 of users 104, for example, user 104 interests, preferences, demographic information, or any other suitable information. If event engine 110 detects and event (e.g., transaction, update to vendor 108 incentive, updated user 104 information, etc.), event engine 110 communicates with rules engine 120 to determine whether user 104 qualifies for an incentive offered by vendors 108. In certain embodiments, event engine 110 includes one or more of a processor (e.g., processor 112), an interface (e.g., interface 114), a memory (e.g., memory 116), and a database (e.g., database 118).

Rules engine 120 represents a component of system 100 communicatively coupled to event engine 110 and settlement engine 130 and operable to determine whether users 104 qualify for incentives offered by vendors 108. In certain embodiments, rules engine 120 receives incentives from participating vendors 108. Incentives may further include one or more conditions from vendors 108 for users 104 to satisfy to qualify for the particular incentive from vendor 108. Users 104 may qualify for vendor 108 incentives by satisfying a subset of vendor 108 conditions, and the value of the incentive may increase if more conditions are satisfied. In certain embodiments, rules engine 120 receives instructions from enterprise 102 regarding what enterprise 102 users 104 to provide incentives from vendors 108. For example, enterprise 102 may use vendor 108 incentives to further incentivize users 104 to interact with enterprise 102, such as downloading software, providing user 104 information, using additional services of enterprise 102, or any other suitable interaction between users 104 and enterprise 102.

In particular embodiments, rules engine 120 determines whether users 104 qualify for vendor 108 incentives, which qualifying users 104 to communicate the incentive, and what additional action is required for each user 104 to receive the vendor 108 incentive. Rules engine 120 may further track an incentive cap (e.g., a maximum number of incentives allowed by vendor 108). For example, rules engine 120 may only approve a number of users 104 under the incentive cap for a particular incentive. In certain embodiments, rules engine 120 includes one or more of a processor (e.g., processor 122), an interface (e.g., interface 124), a memory (e.g., memory 126), and a database (e.g., database 128).

Settlement engine 130 represents a component of system 100 communicatively coupled to rules engine 120 and operable to complete incentive transactions. For example, settlement engine 130 may communicate notice of vender 108 incentives to users 104 (e.g., through communication devices 106) and may further communicate the additional action required for users 104 to complete in order to receive vendor 108 incentives. In certain embodiments, settlement engine 130 receives notification when users 104 user awarded vendor 108 incentives at vendors 108 and communicate with the sponsoring vendor 108 to settle the incentive transaction. Settlement engine 130 may notify rules engine 120 that vendor 108 incentives have been redeemed by users 104 in order for rules engine 120 to ensure that awarded vendor 108 incentives do not exceed an incentive cap from the sponsoring vendor 108. In certain embodiments, settlement engine 130 includes one or more of a processor (e.g., processor 132), an interface (e.g., interface 134), a memory (e.g., memory 136), and a database (e.g., database 138).

Network 140 represents any suitable network operable to facilitate communication between components of system 100, such as enterprise 102, including event engine 110, rules engine 120, settlement engine 130, users 104, user communication devices 106, and vendors 108. Network 140 may include any interconnecting system capable of transmitting audio, video, electrical signals, optical signals, data, messages, or any combination of the preceding. Network 140 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100.

An engine (e.g., engines 110, 120, and 130) may be implemented using logic units, field programmable gate arrays, application specific integrated circuits, digital signal processors, servers, or any other suitable hardware, and may be operable to execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of an engine may be performed by any suitable combination of one or more servers or other components at one or more locations. In embodiments where engines operate on a server, the server may be a private server, and the server may be a virtual or physical server. Additionally, an engine may include any suitable component that functions as a server.

Components of system 100, such as event engine 110, rules engine 120, settlement engine 130, and communication devices 106, may include one or more processors. A processor represents any computing device, such as processors 112, 122, and 132, configured to process data and to implement various instructions, for example, to control the operation of one or more components of system 100. A processor may comprise one or more processors and may be a programmable logic device, a microcontroller, a microprocessor, any suitable processing device, or any suitable combination of the preceding. A processor includes any hardware or software that operates to control and process information received by a component of system 100. In certain embodiments, a processor communicatively couples to other components of system 100, such as an engine (e.g., engines 110, 120, and 130), an interface (e.g., interfaces 114, 124, and 134), a memory (e.g., memories 116, 126, and 136), a database (e.g., databases 118, 128, and 138), or any other suitable component.

An interface represents any device, such as interfaces 114, 124, and 134 operable to receive input, send output, process the input or output, or perform other suitable operations for a component of system 100. An interface includes any port or connection, real or virtual, including any suitable hardware or software, including protocol conversion and data processing capabilities, to communicate through network 140. In certain embodiments, an interface includes a user interface (e.g., physical input, graphical user interface, touchscreen, buttons, switches, transducer, or any other suitable method to receive input from a user).

A memory represents any device, such as memories 116, 126, and 136 operable to store, either permanently or temporarily, data, operational software, or other information for a processor. Memory includes any one or a combination of volatile or non-volatile local or remote devices suitable for storing information. For example, a memory may include random access memory (RAM), read only memory (ROM), magnetic storage devices, optical storage devices, semiconductor storage devices, or any other suitable information storage device or a combination of these devices. A memory may include any suitable information for use in the operation of component of system 100. A memory may further include some or all of one or more databases (e.g., databases 118, 128, and 138).

Logic may perform the operation of any component of system 100, for example, logic executes instructions to generate output from input. Logic may include hardware, software, or other logic. Logic may be encoded in one or more non-transitory, tangible media, such as a computer-readable medium or any other suitable tangible medium, and may perform operations when executed by a computer or processor. Certain logic, such as a processor, may manage the operation of a component.

System 100 allows for enterprise 102 to provide high value incentives to users 104 to interact with enterprise 102 by maximizing the value of vendor 108 incentives to both users 104 and to vendors 108 sponsoring incentives. For example, because enterprise 102 has access to transaction information associated with a user account and/or user information associated with users 104, and may be able to detect events (such as transactions) in near real-time, enterprise 102 can identify incentives that would have the highest value to particular users 104 and to present those incentives at times when users 104 are most interested in receiving the incentive. Additionally, system 100 can provide highly targeted users 104 for vendors 108 sponsoring incentives, thereby increasing the value of incentives vendors 108 are willing to offer. Further, enterprise 102 benefits from high value incentives from vendors 108 because those high value incentives are more likely to motivate a customer to perform required interactions with enterprise 102 in order to receive the high value incentive.

For example, system 100 can determine customers that patronize similar vendors 108 to a sponsoring vendor 108, but that have not made recent purchases from the sponsoring vendor 108. This capability allows a sponsoring vendor 108 to target users 104 who are interested in the goods or services offered by the sponsoring vendor 108, but that are not already customers of vendor 108. Similarly, system 100 allows sponsoring vendors 108 to target existing customers with additional or new products or services (e.g., upselling) offered by the sponsoring vendor 108. For example, a sponsoring vendor 108 operating as a coffee shop could target customers that have made a transaction with the sponsoring vendor 108 in the last week, but with transactions under $5.00 (e.g., indicating customers that are likely buying only coffee) with incentives to try food items offered by the sponsoring vendor 108.

Additionally, vendors 108 could target users 106 most likely to be profitable within the business model of a sponsoring vendor 108. For example, sponsoring vendor 108 operating as a cruise line that has high margin on food and beverages may be willing to offer large discounts on cruise tickets to users 104 that are most likely to spend on the high margin food and beverages offered on the cruise. The sponsoring vendor 108 could target users over 21 who regularly patronize restaurants and bars and that have spent over a threshold amount of money at restaurants and bars in the past thirty days.

Vendors 108 may also be able to target users 104 that would be most interested in certain products or services. For example, a sponsoring vendor operating as a golf store and wanting to increase patronage of its golf simulators may target users 104 that have had a threshold number of transactions at golf courses in the past ninety days and offer golf simulator specials in regions where weather has ended the outdoor golf season.

Enterprise 102 also benefits because it can request that users 104 perform some interaction with enterprise 102 in order to receive the higher value incentives offered from vendors 108. Further, system 100 does not reveal user 104 information or user 104 transaction information to third parties (e.g., vendors 108) so user 104 information remains safe with enterprise 102 that is already trusted with user 104 data. System 100 operates like a trap door allowing vendors 108 to target users 104 with certain characteristics or transaction patterns without ever providing vendors 108 with user 104 information.

System 100 may also be able to present incentives to users 104 at times when users 104 are most receptive to the offer. For example, system 100 (e.g., settlement engine 130) could present a user 104 that often has a transaction with a vendor 108 categorized as a “coffee shop” after 7:30 AM on weekdays with an incentive from a vendor 108 in the “coffee shop” category at 7:00 AM on a weekday when the user 104 is most receptive to the incentive. In certain embodiments, users 104 may enable location tracking on an application operating on a communication device 106 associated with the users 104, and system 100 could present incentives from vendors 108 in the current area of users 104 at times the users 104 would be most receptive to the incentives (e.g., incentives from vendors 108 categorized as restaurants in the area of users 106 at meal times).

As such, system 100 allows vendors 108 to benefit from being able offer incentives to highly targeted sets of users 104, allows users 104 to benefit from receiving higher value incentives from vendors 108 that users 104 are likely to be most interested in patronizing, and allows enterprise 102 to benefit by requiring additional user 104 interaction (e.g., patronizing enterprise 102, providing information to enterprise 102, advertising for enterprise 102, or any other suitable interaction) in order to obtain the high value incentives offered by vendors 108.

Modifications, additions, or omissions may be made to system 100. System 100 may include more, fewer, or other components. Any suitable component of system 100 may include a processor, interface, logic, memory, or other suitable element.

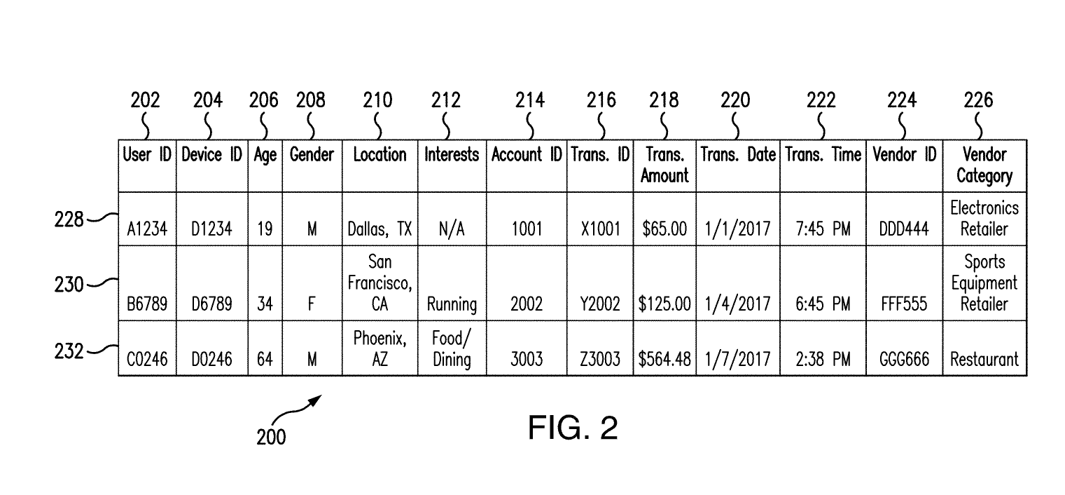

FIG. 2 illustrates table 200 of user information in an example system for providing user incentives. In the illustrated embodiment, table 200 includes User ID field 202, Device ID field 204, Age field 206, Gender field 208, Location field 210, Interests field 212, Account ID field 214, Transaction ID field 216, Transaction Amount field 218, Transaction Date field 220, Transaction Time field 222, Vendor ID field 224, and Vendor Category field 226.

User ID field 202 represents a field that includes an identifier (e.g., ID code) for particular users 104 associated with enterprise 102. Device ID field 204 represents an identifier (e.g., phone number, machine address code, Internet Protocol address, or other identifier) associated with a communication device (e.g., smart phone or tablet) associated with the user 104 identified in User ID field 202. Age field 206 represents a field that includes an age associated with the user 104 identified in User ID field 202. Gender field 208 represents a field that includes a gender associated with the user 104 identified in User ID field 202. Location field 210 represents a field that includes a geographical location (e.g., city, region, market, GPS coordinates, or other suitable identifier) associated with the user 104 identified in User ID field 202 and/or the transaction identified in Transaction ID field 210. In certain embodiments, table 200 includes location fields for both the user 104 identified in User ID field 202 and for the transaction identified in Transaction ID field 216. Interests field 212 represents a field that includes interests (e.g., hobbies or pastimes) associated with the user 104 identified in User ID field 202. Interests may be identified based on transactions associated with the user 104 identified in User ID field 202 and/or from information received from the user 104 identified in User ID field 202 (e.g., through an application associated with enterprise 102 operating on communication device 106 associated with user 104).

Account ID field 214 represents a field that includes an identifier of an account associated with the user 104 identified in User ID field 202. The account may be a financial account, a rewards, account, or any other suitable type of account. In certain embodiments, the account is associated with enterprise 102. Users 104 may be associated with multiple accounts and accordingly multiple accounts may be associated with a single value in the User ID field 202. Transaction ID field 216 represents a field that includes an identifier associated with a transaction involving the account identified in Account ID field 214. Transaction Amount field 218 represents a field that includes an amount of money associated with the transaction identified in Transaction ID field 216. Transaction Date field 220 represents a field that includes a date associated with the transaction identified in Transaction ID field 216. Transaction Time field 222 represents a field that includes a time associated with the transaction identified in Transaction ID field 216. Vendor ID field 224 represents a field that includes an identification of a vendor (e.g., vendor 108), such as a retailer, involved in the transaction identified in Transaction ID field 216. Vendor Category field 226 represents a category assigned (e.g., by enterprise 102, vendor 108, and/or users 104) to the vendor identified in the Vendor ID field 224. System 100 may populate fields of table 200 from information stored by enterprise 102 associated with enterprise 102 accounts (e.g., Account ID field 214) associated with users 104 and/or from information received from user 104, such as through a communication device 106 associated with user 104 (e.g., from an application associated with enterprise 102 operating on communication device 106).

Rows 228, 230, and 232 illustrate an example embodiment of database values for database fields of table 200. Row 228 depicts “A1234” in User ID field 202, “D1234” in Device ID field 204, “19” in Age field 206, “M” in Gender field 208, “Dallas, Tex.” in Location field 210, “N/A” in Interests field 212, “1001” in Account ID field 214, “X1001” in Transaction ID field 216, “$65.00” in Transaction Amount field 218, “Jan. 1, 2017” in Transaction Date field 220, “7:45 PM” in Transaction Time field 222, “DDD444” in Vendor ID field 224, and “Electronics Retailer” in Vendor Category field 226. Row 228 illustrates that user 104 identified by “A1234” and associated with communication device 106 identified by “D1234” is a 19 year old male who lives in Dallas, Tex. and made a $65.00 transaction using account “1001” on Jan. 1, 2017 at 7:45 PM at a vendor 108 identified as “DDD444” that is categorized as an “Electronics Retailer.” In the example illustrated by row 228, table 200 does not have data on “interests,” for example, because the user 104 identified as “A1234” has not submitted his interests to enterprise 102. Row 228 is only an example, and table 200 may contain a plurality of rows associated with a single user 104 describing a plurality of transactions and may include a plurality of accounts.

Row 230 depicts “B6789” in User ID field 202, “D6789” in Device ID field 204, “34” in Age field 206, “F” in Gender field 208, “San Francisco, Calif.” in Location field 210, “Running” in Interests field 212, “2002” in Account ID field 214, “Y2002” in Transaction ID field 216, “$125.00” in Transaction Amount field 218, “Jan. 4, 2017” in Transaction Date field 220, “6:45 PM” in Transaction Time field 222, “FFF555” in Vendor ID field 224, and “Sports Equipment Retailer” in Vendor Category field 226. Row 230 illustrates that user 104 identified by “B6789” and associated with communication device 106 identified by “D6789” is a 34 year old female who lives in San Francisco, Calif. and made a $125.00 transaction using account “2002” on Jan. 4, 2017 at 6:45 PM at a vendor 108 identified as “FFF555” that is categorized as a “Sports Equipment Retailer.” In the example illustrated by row 230, Interests field 212 includes “Running,” for example, because the user 104 identified as “B6789” has identified “running” as an interest to enterprise 102 and/or because enterprise 102 has determined that user 104 identified as “B6789” is interested in running based on her transaction history. Row 230 is only an example, and table 200 may contain a plurality of rows associated with a single user 104 describing a plurality of transactions and may include a plurality of accounts.

Row 232 depicts “C0246” in User ID field 202, “D0246” in Device ID field 204, “64” in Age field 206, “M” in Gender field 208, “Phoenix, Ariz.” in Location field 210, “Food/Dining” in Interests field 212, “3003” in Account ID field 214, “Z3003” in Transaction ID field 216, “$564.48” in Transaction Amount field 218, “Jan. 7, 2017” in Transaction Date field 220, “2:38 PM” in Transaction Time field 222, “GGG666” in Vendor ID field 224, and “Restaurant” in Vendor Category field 226. Row 230 illustrates that user 104 identified by “C0246” and associated with communication device 106 identified by “D0246” is a 64 year old male who lives in Phoenix, Ariz. and made a $564.48 transaction using account “3003” on Jan. 7, 2017 at 2:38 PM at a vendor 108 identified as “GGG666” that is categorized as “Restaurant.” In the example illustrated by row 232, Interests field 212 includes “Food/Dining,” for example, because the user 104 identified as “C0246” has identified “Food/Dining” as an interest to enterprise 102 and/or because enterprise 102 has determined that user 104 identified as “C0246” is interested in food/dining based on his transaction history. Row 232 is only an example, and table 200 may contain a plurality of rows associated with a single user 104 describing a plurality of transactions and may include a plurality of accounts.

Modifications, additions, or omissions may be made to table 200. Table 200 may include more or less fields, and may include any suitable information relevant to user 104 transactions and/or user 104 information. Table 200 may include any suitable amount of information and may be stored in any suitable type or number of memories.

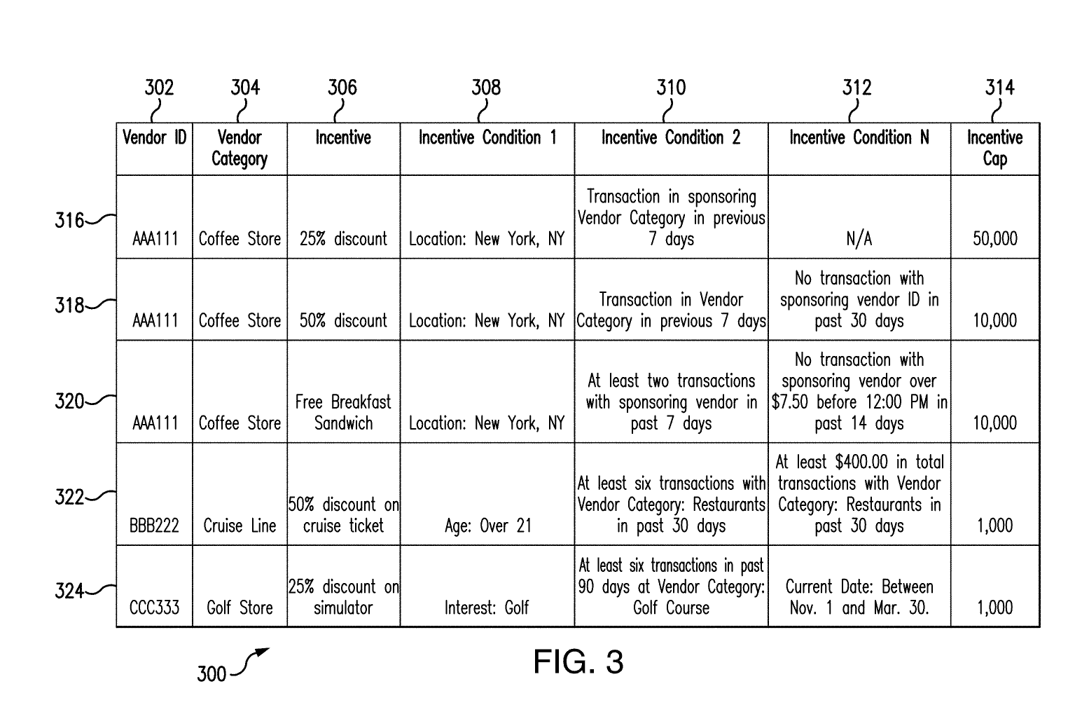

FIG. 3 illustrates a table of vendor incentive information in an example system for providing user incentives. In the illustrated embodiment, table 300 includes Vendor ID field 302, Vendor Category field 304, Incentive 306, Incentive Condition 1 field 308, Incentive Condition 2 field 310, Incentive Condition N field 312, and Incentive Cap field 314. Vendor ID field 302 represents a field that includes an identification of a vendor (e.g., vendors 108), such as a retailer, that is sponsoring an incentive (e.g., a reward, discount, offer, sale, giveaway, contests, or any other incentive), such as an incentive identified in Incentive field 306. Vendor Category field 304 represents a category assigned to the vendor (e.g., by enterprise 102, vendor 108, and/or users 104) identified in the Vendor ID field 302. Incentive field 306 represents a field that includes an identifier of an incentive associated with the vendor 108 identified in Vendor ID field 302. Incentive Condition 1 field 308, Incentive Condition 2 field 310, and Incentive Condition N field 312 represent fields that include conditions associated with the incentive identified in Incentive field 306. Table 300 may include any number of conditions associated with particular incentives. Incentive Cap field 314 represents a field that includes a cap (e.g., maximum number) of times the incentive can be awarded to users 104.

Rows 316, 318, 320, 322, and 324 illustrate an example embodiment of database values for database fields of table 300. Row 316 depicts “AAA111” in Vendor ID field 302, “Coffee Store” in Vendor Category field 304, “25% discount” in Incentive filed 306, “Location: New York, N.Y.” in Incentive Condition 1 field 308, “Transaction in sponsoring Vendor Category in previous 7 days” in Incentive Condition 2 field 310, “N/A” in Incentive Condition N field 312, and “50,000” in Incentive Cap field 314. Row 316 illustrates that a vendor 108 identified as “AAA111” is categorized as a “Coffee Store” and has offered an incentive of a “25% discount” to users 104 that are in New York, N.Y. (Incentive Condition 1) and have had a transaction involving a vendor from the same vendor category (e.g., Coffee Store) as the sponsoring vendor (identified as “AAA111”) in the previous seven days (Incentive Condition 2) and the sponsoring vendor has set a cap of “50,000” for this incentive.

Row 318 depicts “AAA111” in Vendor ID field 302, “Coffee Store” in Vendor Category field 304, “50% discount” in Incentive filed 306, “Location: New York, N.Y.” in Incentive Condition 1 field 308, “Transaction in sponsoring Vendor Category in previous 7 days” in Incentive Condition 2 field 310, “No transaction with sponsoring Vendor ID in previous 30 days” in Incentive Condition N field 312, and “10,000” in Incentive Cap field 314. Row 318 illustrates that a vendor 108 identified as “AAA111” is categorized as a “Coffee Store” and has offered an incentive of a “50% discount” to users 104 that are in New York, N.Y. (Incentive Condition 1) and have had a transaction involving a vendor from the same vendor category (e.g., Coffee Store) as the sponsoring vendor (identified as “AAA111”) in the previous seven days (Incentive Condition 2), and have not had a transaction with the sponsoring vendor in the previous thirty days (Incentive Condition N), and the sponsoring vendor has set a cap of “10,000” for this incentive.

Rows 316 and 318 illustrate that vendors may be willing to offer higher value incentives to users 104 that most closely meet the vendor's target of the incentive (e.g., users 104 that satisfy more conditions may qualify for higher value incentives). For example, the conditions of row 316 allow the vendor to target patrons of “Coffee Stores” (e.g., the vendor category) in a particular location (e.g., New York, N.Y.) and the vendor is willing to provide a 25% discount as an incentive to these customers. However, there is additional value to the vendor to target patrons of “Coffee Stores in New York, N.Y. who are not already customers of the vendor. Accordingly, the vendor is willing to offer a higher value incentive (50% discount compared to 25% discount) to target users 104 who have not had a transaction with the sponsoring vendor in the previous thirty days.

Row 320 depicts “AAA111” in Vendor ID field 302, “Coffee Store” in Vendor Category field 304, “Free Breakfast Sandwich” in Incentive filed 306, “Location: New York, N.Y.” in Incentive Condition 1 field 308, “At least two transactions with sponsoring vendor in past 7 days” in Incentive Condition 2 field 310, “No transactions with sponsoring vendor over $7.50 before 12:00 PM in past 14 days” in Incentive Condition N field 312, and “10,000” in Incentive Cap field 314.

Row 320 illustrates that a vendor 108 identified as “AAA111” is categorized as a “Coffee Store” and has offered an incentive of a “Free Breakfast Sandwich” to users 104 that are in New York, N.Y. (Incentive Condition 1) and have had a transaction involving the sponsoring vendor (identified as “AAA111”) in the previous seven days (Incentive Condition 2), and have not had a transaction with the sponsoring vendor over $7.50 before 12:00 PM in the past 14 days (Incentive Condition N), and the sponsoring vendor has set a cap of “10,000” for this incentive.

Row 320 illustrates how vendors 108 can use system 100 to target users 104 most interested in particular incentives. In row 320, the sponsoring vendor 108 is able to target users 104 that already regularly patronize the sponsoring vendor 108 but that are not likely purchasing breakfast sandwiches (as indicated by the transaction amount). These targeted users 104 are more valuable to vendor 108 and vendor 108 may be willing to offer higher value incentives to these users 104. Similarly, these users 104 are already patrons of the sponsoring vendor 108 and are most likely to find the incentive valuable.

Row 322 depicts “BBB222” in Vendor ID field 302, “Cruise Line” in Vendor Category field 304, “50% discount on cruise ticket” in Incentive filed 306, “Age: Over 21” in Incentive Condition 1 field 308, “At least 6 transactions with Vendor Category: Restaurants in past 30 days” in Incentive Condition 2 field 310, “At least $400.00 in total transactions with Vendor Category: Restaurants in past 30 days” in Incentive Condition N field 312, and “1,000” in Incentive Cap field 314.

Row 322 illustrates that a vendor 108 identified as “BBB222” is categorized as a “Cruise Line” and has offered an incentive of a “50% discount on a cruise ticket” to users 104 that are over 21 years old (Incentive Condition 1), have had at least six transactions with vendors 108 categorized as “restaurants” in the past 30 days (Incentive Condition 2), and have totaled at least $400.00 in transactions with vendors 108 categorized as “restaurants” in the past 30 days (Incentive Condition N), and the sponsoring vendor has set a cap of “1,000” for this incentive.

Row 322 illustrates how vendors 108 can use system 100 to target users 104 most interested in particular incentives. In row 322, the sponsoring vendor 108 is able to target users 104 that are most likely to patronize food and beverage options offered by the sponsoring vendor 108 and that have spent at least $400.00 in the past 30 days on such products. The sponsoring vendor 108 may be willing to offer large discounts on ticket prices because the sponsoring vendor 108 believes these particular users will purchase other products and services from the sponsoring vendor 108 (e.g., loss leader strategy).

Row 324 depicts “CCC333” in Vendor ID field 302, “Golf Store” in Vendor Category field 304, “25% discount on simulator” in Incentive filed 306, “Interest: Golf” in Incentive Condition 1 field 308, “At least 6 transactions in past 90 days at Vendor Category: Golf Course” in Incentive Condition 2 field 310, “Current Date: between November 1 and March 30” in Incentive Condition N field 312, and “1,000” in Incentive Cap field 314.

Row 324 illustrates that a vendor 108 identified as “CCC333” is categorized as a “Golf Store” and has offered an incentive of a “25% discount on simulator” to users 104 that are interested in golf (Incentive Condition 1), have had at least six transactions at vendors 108 categorized as golf courses in the past 90 days (Incentive Condition 2), and that the current date is between November 1 and March 30 (Incentive Condition N), and the sponsoring vendor has set a cap of “10,000” for this incentive.

Row 324 illustrates how vendors 108 can use system 100 to target users 104 most interested in particular incentives. In row 320, the sponsoring vendor 108 is able to target users 104 that are interested in golf and regularly patronize golf courses and at a time when outdoor golfing is more difficult because of the seasonal change. These targeted users 104 are more valuable to vendor 108 and vendor 108 may be willing to offer higher value incentives to these users 104. Similarly, these users 104 are most likely to find the incentive valuable.

Modifications, additions, or omissions may be made to table 300. Table 300 may include more or less fields, and may include any suitable information relevant to vendors 108, vendor 108 incentive details, vendor 108 incentive conditions, and vendor 108 incentive caps. Table 300 may include any suitable amount of information and may be stored in any suitable type or number of memories.

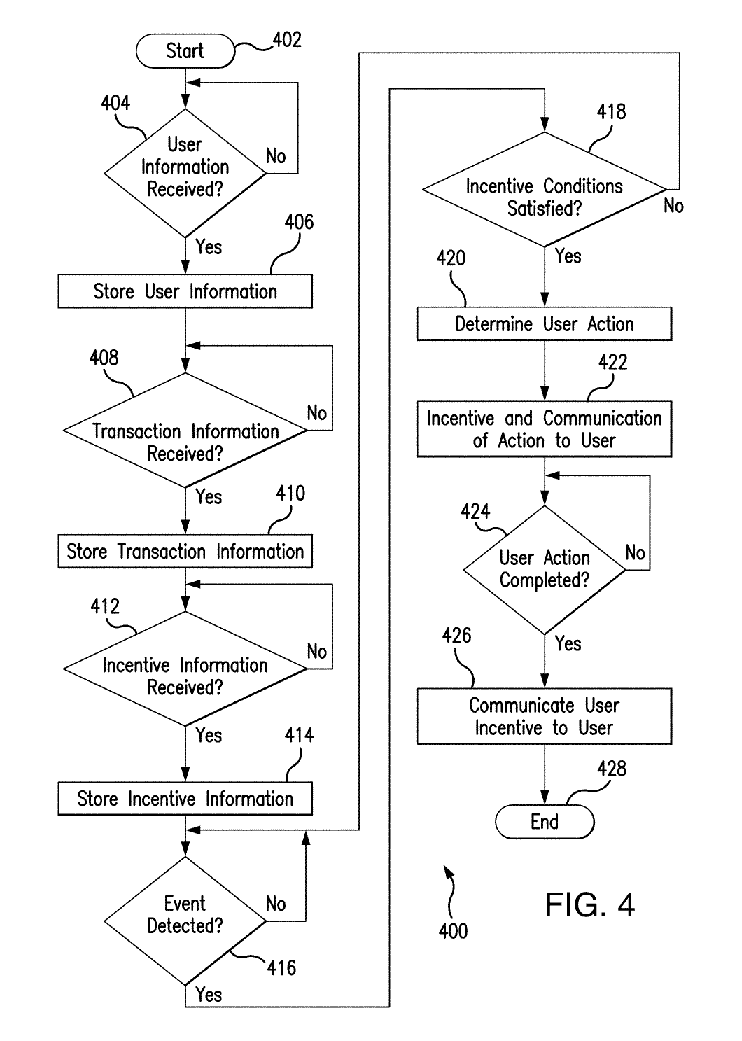

FIG. 4 illustrates a flow diagram of an example method for providing user incentives. Method 400 begins at step 402. At step 404, it is determined whether user information has been received (e.g., information illustrated in one or more of fields 202, 204, 206, 208, and 210 of table 200 of FIG. 2). If user information has not been received, the method returns to step 404 and the system 100 continues to monitor whether user information has been received. If user information has been received, method 400 continues to step 406. At step 406, the received user information is stored (e.g., in one or more tables of one or more databases such as the example illustrated in table 200 of FIG. 2).

At step 408, it is determined whether transaction information has been received (e.g., information illustrated in one or more of fields 210, 212, 214, 216, 218, 220, 222, 224, and 226 of table 200 of FIG. 2). If transaction information has not been received, the method returns to step 408 and the system 100 continues to monitor whether transaction information has been received. If transaction information has been received, method 400 continues to step 410. At step 410, the received transaction information is stored (e.g., in one or more tables of one or more databases such as the example illustrated in table 200 of FIG. 2).

At step 412, it is determined whether incentive information has been received (e.g., information illustrated in one or more of the fields of table 300 of FIG. 3). If incentive information has not been received, the method returns to step 412 and the system 100 continues to monitor whether transaction incentive information has been received. If incentive information has been received, method 400 continues to step 414. At step 414, the received incentive information is stored (e.g., in one or more tables of one or more databases such as the example illustrated in table 300 of FIG. 3).

At step 416, it is determined whether an event related to a user incentive has been detected (e.g., by event engine 110). If an event has not been detected, the method returns to step 416 and the system 100 continues to monitor for an event related to a user incentive. If an event related to a user incentive is detected, method 400 continues to step 418. At step 418, it is determined whether the user 104 transaction has satisfied the conditions for any user incentive (e.g., such as the conditions illustrated in table 300 of FIG. 3). If the transaction does not satisfy the conditions for any user incentive, the method returns to step 416 and the system 100 continues to monitor whether a user 104 has conducted a transaction. If the transaction does satisfy the conditions for a user incentive, method 400 continues to step 420. At step 420, a user action is determined (e.g., by rules engine 120 of system 100) for the user 104 identified for the incentive. At step 422, an identification of the incentive and the user action required to receive the incentive is communicated to the user 104 (e.g., by settlement engine 130).

At step 424, it is determined whether the user 104 has completed the user action to receive the incentive (e.g., by settlement engine 130). If the user 104 has not completed the user action, method 400 returns to step 424 and system 100 continues to monitor for the user 104 to complete the user action. If the user 104 has completed the user action, method 400 continues to step 426. At step 426, the incentive is communicated to the user 104 (e.g., by settlement engine 130). Method 400 ends at step 428.

Modifications, additions, or omissions may be made to method 300. The method may include more, fewer, or other steps. Additionally, steps may be performed in any suitable order, in parallel, and/or sequentially. Any suitable component of may perform one or more steps of method 400.

Certain embodiments of the present disclosure may provide one or more technical advantages having specific technical effects.

In certain embodiments, system 100 is operable to facilitate vendors targeting specific groups of customers according to sensitive user information and user transaction information without revealing that information to the vendors, thereby maintaining the security of sensitive user information.

In particular embodiments, system 100 is operable to communicate vendor incentives to targeted customers at times the targeted customers are likely to be most receptive to the vendor incentive, thereby conserving computing resources and bandwidth consumed by communicating untargeted vendor incentives (e.g., needing more communications for the same outcome).

In another embodiment, system 100 is operable to communicate vendor incentives to targeted customers when the targeted customers are located near the sponsoring vendor and likely to be most receptive to the vendor incentive, thereby conserving computing resources and bandwidth consumed by communicating untargeted vendor incentives (e.g., needing more communications for the same outcome).

In yet another embodiment, system 100 is operable to communicate vendor incentives to targeted customers based on the customers' account transaction history, thereby conserving computing resources and bandwidth consumed by communicating untargeted vendor incentives (e.g., needing more communications for the same outcome).

Other technical advantages of the present disclosure will be readily apparent to one skilled in the art from the following figures, descriptions, and claims. Moreover, while specific advantages have been enumerated above, various embodiments may include all, some, or none of the enumerated advantages.

What is claimed is:

1. A system for providing user incentives, comprising:
a memory comprising a database, the database including user information related to a plurality of communication device application users, the user information including for each user: an identifier of a communication device associated the user, an identifier of an account associated with the user, user age, user gender, and user location;
an interface communicatively coupled to the memory and operable to receive transaction information regarding transactions involving an identified account associated with the user, including: transaction amount, transaction date, transaction time, and vendor;
the memory further operable to store the received transaction information in the database;
the interface further operable to receive one or more user incentives and one more conditions for each user incentive;
the memory further operable to store the received one or more user incentives and associated one or more conditions for each user incentive in the database;
one or more processors communicatively coupled to the memory, the one or more processors operable to:
determine that a user has conducted a transaction using an identified account associated with the user;
determine, based on the received transaction information associated with the transaction and the user information, that the user has satisfied the conditions to qualify for a user incentive;
determine a user action for the user to complete in order to receive the incentive;
generate a communication to a communication device associated with the user notifying the user of the incentive and the user action required for the user to receive the incentive;
determine that the user has completed the user action; and
communicate the user incentive to the user.

2. The system of claim 1, wherein the received incentives are associated with a vendor providing the incentive, the received incentives have a plurality of conditions received from the vendor providing the incentive, a user can qualify for the incentive by satisfying a subset of the plurality of conditions, and the value of the incentive increases based on the number of conditions satisfied by a user.

3. A system for providing user incentives, comprising:
a memory comprising a database, the database including user information related to a plurality of communication device application users, the user information including for each user: an identifier of a communication device associated with the user and an identifier of an account associated with the user;
an interface communicatively coupled to the memory and operable to receive transaction information regarding transactions involving an identified account associated with the user, including one or more from the set comprising: transaction amount, transaction date, transaction time, and vendor;
the memory further operable to store the received transaction information in the database;
the interface further operable to receive one or more user incentives and one more conditions for each user incentive;
the memory further operable to store the received one or more user incentives and associated one or more conditions for each user incentive in the database;
one or more processors communicatively coupled to the memory, the one or more processors operable to:
determine that a user has conducted a transaction using an identified account associated with the user;
determine, based on the received transaction information associated with the transaction, that the user has satisfied the conditions to qualify for a user incentive;
determine a user action for the user to complete in order to receive the incentive;
generate a communication to a communication device associated with the user notifying the user of the incentive and the user action required for the user to receive the incentive;
determine that the user has completed the user action; and
communicate the user incentive to the user.

4. The system of claim 2, the user information further including one or more from the set comprising: age, location, gender, and interests; and
the one or more processors further operable to determine, based on the user transaction information and the user information, that the user has satisfied the conditions to qualify for a user incentive.

5. The system of claim 2, wherein the received incentives are associated with a vendor providing the incentive, the received incentives have a plurality of conditions, a user can qualify for the incentive by satisfying a subset of the plurality of conditions, and the value of the incentive increases based on the number of conditions satisfied by a user.

6. The system of claim 5, wherein the conditions associated with an incentive are received from a vendor providing the incentive.

7. The system of claim 2, wherein the user action for the user to complete in order to receive the incentive is completed through the communication device application.

8. The system of claim 2, wherein the user action for the user to complete in order to receive the incentive is determined by a financial institution associated with the identified account associated with the user.

9. A computer readable storage medium comprising logic for providing user incentives, the logic, when executed by a processor, operable to:
receive user information related to a plurality of communication device application users, the user information including for each user: an identifier of a communication device associated with the user and an identifier of an account associated with the user;
receive transaction information regarding transactions involving an identified account associated with the user, including one or more from the set comprising: transaction amount, transaction date, transaction time, and vendor;
receive one or more user incentives and associated one or more conditions for each user incentive;
store the received user information, the associated transaction information, the one or more user incentives, and the associated one or more conditions for each user incentive in a database;
determine that a user has conducted a transaction using an identified account associated with the user;
determine, based on the received transaction information associated with the transaction, that the user has satisfied the conditions to qualify for a user incentive;
determine a user action for the user to complete in order to receive the incentive;
generate a communication to a communication device associated with the user notifying the user of the incentive and the user action required for the user to receive the incentive;
determine that the user has completed the user action; and
communicate the user incentive to the user.

10. The computer readable medium of claim 9, the logic further operable to determine, based on the user transaction information and the user information, that the user has satisfied the conditions to qualify for a user incentive, wherein the user information further includes one or more from the set comprising: age, location, gender, and interests.

11. The computer readable medium of claim 9, wherein the received incentives are associated with a vendor providing the incentive, the received incentives have a plurality of conditions, a user can qualify for the incentive by satisfying a subset of the plurality of conditions, and the value of the incentive increases based on the number of conditions satisfied by a user.

12. The computer readable medium of claim 11, wherein the conditions associated with an incentive are received from a vendor providing the incentive.

13. The computer readable medium of claim 9, wherein the user action for the user to complete in order to receive the incentive is completed through the communication device application.

14. The computer readable medium of claim 9, wherein the user action for the user to complete in order to receive the incentive is determined by a financial institution associated with the identified account associated with the user.

15. A method for providing user incentives, comprising:
receiving user information related to a plurality of communication device application users, the user information including for each user: an identifier of a communication device associated with the user and an identifier of an account associated with the user;
receiving transaction information regarding transactions involving an identified account associated with the user, including one or more from the set comprising: transaction amount, transaction date, transaction time, and vendor;
receiving one or more user incentives and associated one or more conditions for each user incentive;
storing the received user information, the associated transaction information, the one or more user incentives, and the associated one or more conditions for each user incentive in a database;
determining that a user has conducted a transaction using an identified account associated with the user;
determining, based on the received transaction information associated with the transaction, that the user has satisfied the conditions to qualify for a user incentive;
determining a user action for the user to complete in order to receive the incentive;
generating a communication to a communication device associated with the user notifying the user of the incentive and the user action required for the user to receive the incentive;
determining that the user has completed the user action; and
communicating the user incentive to the user.

16. The method of claim 15, further comprising determining, based on the user transaction information and the user information, that the user has satisfied the conditions to qualify for a user incentive, wherein the user information further includes one or more from the set comprising: age, location, gender, and interests.

17. The method of claim 15, wherein the received incentives are associated with a vendor providing the incentive, the received incentives have a plurality of conditions, a user can qualify for the incentive by satisfying a subset of the plurality of conditions, and the value of the incentive increases based on the number of conditions satisfied by a user.

18. The method of claim 17, wherein the conditions associated with an incentive are received from a vendor providing the incentive.

19. The method of claim 15, wherein the user action for the user to complete in order to receive the incentive is completed through the communication device application.

20. The method of claim 15, wherein the user action for the user to complete in order to receive the incentive is determined by a financial institution associated with the identified account associated with the user.
